(19) United States
(12) Patent Application Publication
(10) Pub. No.: US 2012/0083544 A1
(43) Pub. Date: Apr. 5, 2012

(54) REINFORCED MICROCELLULAR URETHANE PRODUCTS

(75) Inventors: Pratik Shah, Farmington Hills, MI (US); Edward Hosung Park, Saline, MI (US)

(73) Assignee: Freudenberg-NOK General Partnership, Plymouth, MI (US)

(21) Appl. No.: 12/898,406

(22) Filed: Oct. 5, 2010

(51) Int. Cl. C08J 9/00

(52) U.S. Cl. 521/122; 521/159; 521/99

(57) ABSTRACT

A microcellular urethane composition, comprising a polyol component, an isocyanate component having an isocyanate index ratio of from about 65 to about 145; and up to about 50% by weight of a nano-scale filler dispersed throughout the composition. Methods for producing a reinforced microcellular urethane component are also provided.

### INTRODUCTION

The present technology relates to a microcellular urethane composition reinforced with a nano-scale filler. It also relates to a method for making the microcellular composition.

Microcellular urethane products have been shown to be useful in various applications that involve energy absorption, for example, jounce bumpers, seals and gaskets, automotive suspension bushings, and the like. Vehicle suspension systems typically include microcellular urethane components as damping means to absorb relative displacement. Automotive applications are often demanding, however, and such components may be susceptible to adverse operating conditions. Accordingly, there remains a need for improved microcellular urethane compositions that can better withstand the demanding automotive applications.

### SUMMARY

The present technology provides a reinforced microcellular urethane composition. In various aspects, the composition includes a polyol component, an isocyanate component having an isocyanate index ratio of from about 65 to about 145, and up to about 50% by weight of a nano-scale filler dispersed throughout the composition. In certain aspects, the polyol component may comprise a blend of at least two polyols. Similarly, the isocyanate component may comprise a blend of at least two isocyanates.

The present technology also provides a method for producing a reinforced microcellular urethane component. In various aspects, the method comprises dispersing a nano-scale filler with a polyol component to form a polyol mixture. The polyol mixture is metered with an isocyanate component. The isocyanate component may be present in an amount having an isocyanate index ratio of from about 65 and about 145. The method includes blending the resulting mixture and depositing the mixture into a tooling device, forming a reinforced microcellular urethane component.

In other aspects, the methods of the present technology comprise dispersing a nano-scale filler with a polymer mixture. The polymer mixture comprises a polyol component including a blend of polyether polyol and polyester polyol, and an isocyanate component. The isocyanate component may be present in an amount having an isocyanate index ratio of from about 65 to about 145. The method includes blending the resulting mixture and depositing the mixture into a tooling device, forming a reinforced microcellular urethane component.

### DRAWINGS

FIG. 1 is a graph indicating the dynamic stiffness as a function of frequency for various components of the present technology.

FIG. 2 is a graph indicating the loss stiffness as a function of frequency for various components.

FIG. 3 is a graph indicating the damping properties as a function of frequency for various components.

FIG. 4 is a graph indicating the transmissibility as a function of frequency for various components.

It should be noted that the figures set forth herein are intended to exemplify the general characteristics of materials, methods, and devices among those of the present technology, for the purpose of the description of certain embodiments. These figures may not precisely reflect the characteristics of any given embodiment, and are not necessarily intended to define or limit specific embodiments within the scope of this technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. A non-limiting discussion of terms and phrases intended to aid understanding of the present technology is provided at the end of this Detailed Description.

The present technology is directed to reinforced microcellular urethane compositions, particularly for use with vibration suspension applications, and methods for producing the same. By way of example, the compositions of the present technology may be used by themselves or in combination with devices or components, as automotive jounce bumper parts, spring aids, body mounts, spring isolators, sub frame mounts, suspension bushings, shear mount isolators, and the like.

As is known in the art, a polyurethane is essentially any polymer that includes a chain of organic units joined together by urethane (carbamate) links. Urethane linkage is produced by reacting an isocyanate functional group with a hydroxyl (alcohol) group. In the most basic of terms, polyurethane polymers are formed through stepwise polymerization by reacting a first monomer having at least two isocyanate functional groups with a second monomer (polyol) having at least two hydroxyl groups, in the presence of a catalyst. The present technology includes the development of microcellular polyurethane formulations with well balanced properties and product applications through the improvement of the physical and chemical properties. Specifically, the present technology provides microcellular urethane compositions that are reinforced with nano-scale fillers. The careful addition of nano-scale fillers dispersed within a microcellular urethane composition provides an efficient internal polymer network and improves various properties, such as (in various embodiments) tensile strength, tear strength, flexural strength, hydrolysis resistance, low and high temperature resistance, compression set values, and dynamic properties.

### Polyols

Polyols are higher molecular weight materials made from an initiator and monomeric building blocks. They are commonly classified as polyether polyols, which are made by the reaction of epoxides (oxiranes) with an active hydrogen containing starter compounds, or polyester polyols, which are made by the polycondensation of multifunctional carboxylic acids and hydroxyl compounds. Such polyols may be formed by base-catalyzed addition of propylene oxide (PO), ethylene oxide (EO) onto a hydroxyl or amine containing initiator, or by polyesterification of a di-acid, such as adipic acid, with glycols, such as ethylene glycol or dipropylene glycol (DPG). Polyols useful with the present technology include various high molecular weight polyol components including the traditional polyester polyols and polyether polyols, as well as specialty-type polyols, including polylactone polyols, polycaprolactone polyols, polytetrahydrofuran polyols, polycarbonate polyols, polybutadiene polyols, polysulfide polyols, natural oil polyols (e.g., castor oil, vegetable oils), fluorinated polyols, and combinations and mixtures thereof. In various aspects of the present technology, the microcellular urethane composition may include one type of polyol. In other preferred aspects, the microcellular urethane composition may contain a polyol system, or a combination/blend of polyols. For example, in one preferred embodiment, the polyol component is provided as a polyol system including a polyether polyol and a polyester polyol. The blend may include from about 10% to about 50% by weight of polyether polyol and from about 50% to about 90% by weight of polyester polyol, or from about 20% to about 40% polyether polyol and from about 60% to about 80% polyester polyol, or about 25% polyether polyol and about 75% polyester polyol. The combination of polyols may vary based on the desired mechanical properties of the final composition.

Polyols formed by polyesterification are polyester polyols. They can be distinguished by their choice of monomers, molecular weight, and degree of branching. By way of example, a polyester based polyol system may provide enhanced benefits regarding solvent and oil resistance, chemical resistance, tear strength, cut resistance, UV resistance, thermal stability, and/or abrasion resistance when compared to a polyol system that is not polyester based. Polyester polyols may be based on virgin raw materials or optionally based on reclaimed raw materials.

Polyols extended with propylene oxide or ethylene oxide are polyether polyols. A polyether based polyol system may provide enhanced benefits regarding water resistance, low temperature flexibility, rebound resilience, resistance to microbial growth and fungus, compressive strength, and/or viscosity properties when compared to a polyol system that is not polyether based.

Important characteristics of polyols include their molecular backbone, initiator, molecular weight, % primary hydroxyl groups, functionality, and viscosity. The choice of initiator, extender, and molecular weight of the polyol affect its physical state, and the physical properties of the polyurethane polymer. By way of example, polyols for flexible applications use low functionality initiators, while polyols for more rigid applications use higher functionality initiators.

Polyester diols may be prepared by the condensation polymerization of polyacid compounds and polyol compounds. Preferably, the polyacid compounds and polyol compounds are di-functional, i.e., diacid compounds and diols are used to prepare substantially linear polyester diols, although minor amounts of mono-functional, tri-functional, and higher functionality materials (for example, up to about 5 mole percent) can be included. Suitable dicarboxylic acids include, without limitation, glutaric acid, succinic acid, malonic acid, oxalic acid, phthalic acid, hexahydrophthalic acid, adipic acid, maleic acid and mixtures of these. Suitable polyols include, without limitation, wherein the extender is selected from the group consisting of ethylene glycol, diethylene glycol, triethylene glycol, tetraethylene glycol, propylene glycol, dipropylene glycol, tripropylene glycol, tetrapropylene glycol, cyclohexanedimethanol, 2-ethyl-1,6-hexanediol, 1,4-butanediol, 1,5-pentanediol, 1,3-propanediol, butylene glycol, neopentyl glycol, and combinations thereof. Small amounts of triols or higher functionality polyols, such as trimethylolpropane or pentaerythritol, are sometimes included. In one embodiment, the carboxylic acid includes adipic acid and the diol includes 1,4-butanediol. Typical catalysts for the esterification polymerization are protonic acids, Lewis acids, titanium alkoxides, and dialkyltin oxides.

Polylactone diols are polyesters formed by polymerizing a cyclic lactone monomer. They can be prepared by reacting an initiator with a lactone or alkylene oxide chain-extension reagent. The initiator contains active hydrogens. Examples include diols such as ethylene glycol and propylene glycol. Preferred chain-extension reagents include e-caprolactone, ethylene oxide, and propylene oxide. Lactones that can be ring opened by an active hydrogen are well-known in the art. Examples of suitable lactones include, without limitation, ε-caprolactone, γ-caprolactone, β-butyrolactone, β-propiolactone, γ-butyrolactone, α-methyl-γ-butyrolactone, β-methyl-γ-butyrolactone, γ-valerolactone, δ-valerolactone, γ-decanolactone, δ-decanolactone, γ-nonanoic lactone, γ-octanoic lactone, and combinations of these. In one preferred embodiment, the lactone is ε-caprolactone. Lactones useful in the practice of the present technology can also be characterized by the formula:

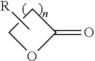

wherein n is a positive integer of 1 to 7 and R is one or more H atoms, or substituted or unsubstituted alkyl groups of 1-7 carbon atoms. Useful catalysts include those mentioned above for polyester synthesis. Alternatively, the reaction can be initiated by forming a sodium salt of the hydroxyl group on the molecules that will react with the lactone ring.

Polyether polyols contain repeating units derived from alkylene oxides. They are typically prepared by reacting an initiator containing active hydrogens with an oxirane-containing compound. Commonly used initiators include water and diols such as ethylene glycol and propylene glycol. The oxirane-containing compound is preferably an alkylene oxide or cyclic ether, especially preferably a compound selected from ethylene oxide, propylene oxide, butylene oxide, tetrahydrofuran, and combinations of these. Alkylene oxide polymer segments include, without limitation, the polymerization products of ethylene oxide, propylene oxide, 1,2-cyclohexene oxide, 1-butene oxide, 2-butene oxide, 1-hexene oxide, tert-butylethylene oxide, phenyl glycidyl ether, 1-decene oxide, isobutylene oxide, cyclopentene oxide, 1-pentene oxide, and combinations of these. The alkylene oxide polymerization is typically base-catalyzed. The polymerization may be carried out, for example, by charging the hydroxyl-functional initiator and a catalytic amount of caustic, such as potassium hydroxide, sodium methoxide, or potassium tert-butoxide, and adding the alkylene oxide at a sufficient rate to keep the monomer available for reaction. Two or more different alkylene oxide monomers may be randomly copolymerized by coincidental addition and polymerized in blocks by sequential addition. Homopolymers or copolymers of ethylene oxide or propylene oxide are preferred.

Polytetrahydrofuran polyols are polymers of tetrahydrofuran, usually formed by ring opening homopolymerization of tetrahydrofuran. Tetrahydrofuran polymerizes under known conditions to form repeating units of —[CH₂CH₂CH₂CH₂O]—. Tetrahydrofuran is polymerized by a cationic ring-opening reaction using such counterions as SbF₆⁻, AsF₆⁻, PF₆⁻, SbCl₆⁻, BF₄⁻, CF₃SO₃⁻, FSO₃⁻, and ClO₄⁻. Initiation is by formation of a tertiary oxonium ion. The polytetrahydrofuran segment can be prepared as a “living polymer” and terminated by reaction with the hydroxyl group of a diol such as any of those mentioned above.

Aliphatic polycarbonate diols are prepared by the reaction of diols with dialkyl carbonates (such as diethyl carbonate), diphenyl carbonate, or dioxolanones (such as cyclic carbonates having five- and six-member rings) in the presence of catalysts like alkali metal, tin catalysts, or titanium compounds. Useful diols include, without limitation, any of those already mentioned. Aromatic polycarbonates are usually prepared from reaction of bisphenols, e.g., bisphenol A, with phosgene or diphenyl carbonate.

The number-average molecular weight is not particularly limited, but in various embodiments, the polymeric polyol preferably has a number average molecular weight (determined for example by the ASTM D-4274 method) of from 100 to 10,000; more preferably from 500 to 8,000; and still more preferably from 1,000 to 4,000.

Chain extension agents may be used and generally include organic compounds having two or more active hydrogen groups. They may comprise difunctional, trifunctional and tetrafunctional low molecular weight compounds containing hydroxyl groups, amino groups, or a combination of hydroxyl and amino groups. Non-limiting examples of diols include ethylene glycol, propylene glycol, 1,6-hexanediol, cyclohexanedimethanol, 2-ethyl-1,6-hexanediol, 1,4-butanediol, neopentyl glycol, 1,4-butanediol, and neopentyl glycol. Diamines include ethylene diamine and hexanediamine. Amino alcohols include alkanolamines such as ethanolamine and propanolamine.

### Isocyanates

The compositions of the present technology may include at least one diisocyanate compound. The isocyanates may have aromatic groups or aliphatic (or cycloaliphatic) groups; aromatically linked isocyanate groups are typically more reactive than aliphatic linked groups. Isocyanates may be modified by partially reacting them with a polyol to form a polymer. Certain characteristics of isocyanates include their molecular backbone, percent NCO content, functionality, and viscosity. In certain embodiments, the isocyanate component is provided as an isocyanate system including at least one aromatic isocyanate and at least one aliphatic isocyanate.

Useful diisocyanate compounds used to prepare the urethane polymers of the present technology include, without limitation, isophorone diisocyanate (IPDI), methylene bis-4-cyclohexyl isocyanate (H₁₂MDI), cyclohexane diisocyanate (CHDI), m-tetramethyl xylene diisocyanate (m-TMXDI), p-tetramethyl xylene diisocyanate (p-TMXDI), ethylene diisocyanate, 1,2-diisocyanatopropane, 1,3-diisocyanatopropane, 1,6-diisocyanatohexane (hexamethylene diisocyanate or HDI), 1-4-cyclohexanebis (methylene isocyanate) (BDI), 1,4-butylene diisocyanate, lysine diisocyanate, 1,4-methylene bis(cyclohexyl isocyanate), bitolylene diisocyanate (TODI), 1-6-diisocyanato-2,2,4,4-tetramethylhexane (TMDI), 1,3-bis(isocyanatomethyl)cyclohexane (H₆XDI), 1,6-diisocyanto-2,4,4,-trimethylhexane, the various isomers of toluene diisocyanate, meta-xylylenediisocyanate, para-xylylenediisocyanate, 4-chloro-1,3-phenylene diisocyanate, naphthalene diisocyanate, 1,5-tetrahydro-naphthalene diisocyanate, 4,4′-dibenzyl diisocyanate, 1,2,4-benzene triisocyanate, 1,4-diisocyanato benzene, xylene diisocyanate (XDI), m-isopropenyl-α,α′-dimethylbenzyl isocyanate (m-TMI), 4,4′-diphenylmethane diisocyanate (CMDI), 1,3-Bis(isocyanatomethyl)cyclohexan (H₁₂XDI), and combinations thereof. Particularly useful is diphenylmethane diisocyanate (MDI) or polymeric MDI (PMDI). In another embodiment, naphthalene diisocyanate (NDI) is used as the diisocyanate. Polymers of naphthalene diisocyanate tend to have superior high temperature properties. Other isocyanate compounds include p-phenylene diisocyante (PPDI) and toluene diisocyanate (TDI). In various aspects of the present technology, the microcellular urethane composition may include one type of isocyanate. In other preferred aspects, the microcellular urethane composition may contain an isocyanate system, or a combination/blend of isocyanates. The combination of isocyanates may vary based on the desired mechanical properties of the final composition.

### Surfactants

In various embodiments, surfactants may be used to modify the characteristics of the polymers of the microcellular composition during the foaming process. Surfactants may be used to control various aspects, including emulsifying liquid components, regulation of cell size, and overall stabilization of the cell structures to minimize or prevent collapse and any surface defects. Surfactant need and selection is typically variable with the choice of polyol system, isocyanate, component compatibilities, additive(s), nano-filler(s), system reactivity, process conditions, process equipment, tooling, part shape, and the like. Surfactants may include polydimethylsiloxane-polyoxyalkylene block copolymers, silicone oils, nonylphenol ethoxylates, and other organic compounds.

### Catalysts

Useful polyurethane catalysts include amine compounds and organometallic compounds. Common amine catalysts tertiary amines include triethylenediamine (TEDA), dimethylcyclohexylamine (DMCHA), and dimethylethanolamine (DMEA). Tertiary amine catalysts are selected based on whether they drive the urethane reaction, the urea reaction, or the isocyanate trimerization reaction. Blow catalysts may have an ether linkage near a tertiary nitrogen. Organometallic compounds based on mercury, lead, tin (dibutyltin dilaurate), bismuth (bismuth octanoate), and zinc may be used. Mercury carboxylates, such as phenylmercuric neodeconate, are effective catalysts for polyurethane elastomer, coating, and sealant applications because they are very highly selective towards the polyol—isocyanate reaction.

### Nano-Scale Fillers

The present technology provides microcellular urethane components reinforced with nano-scale fillers. Non-limiting examples of nano-scale fillers useful with the present technology include nano-scale PTFE, nano-scale silica, carbon nanotubes (single wall and multi wall), nano-scale graphite, nano-scale clays, nano-scale talcs, nano TiC, nano boron, silicone nano particles/powders, and the like, including mixtures thereof The term nano-scale is meant to include fillers in the form of discrete particles having a mean dimension ranging from about 0.001 to about 999.999 nm. It should be understood that the mean dimension or particle size can be increased or decreased, depending on the specific design and selection of materials, and these variations are within the scope of the present technology. It should further be noted that the mean dimension or particle size is not necessarily based on the total number of particles but rather may based on a weight percentage of the nano-scale filler. Certain natural material particles may have unequal dimensions, for example a length greater than a width. In such circumstances, a dimension or particle size refers to at least one dimension having the specified size. Particle size distribution can be determined using Gaussian distribution, or other methods known in the art.

Certain of the nano-scale fillers may be chemically modified with surface treatments to provide fine dispersion and resin coupling so as to provide maximum benefits. In various aspects, the nano-scale filler is provided in an amount up to about 50% by weight of the reinforced microcellular component. Preferably, the composition may comprise from about 0.01% to about 30%, from about 0.01% to about 15%, and even more preferably from about 0.05% to 5% by weight of nano-scale filler, depending on the desired features of the composition.

### Optional Materials

In addition to the nano-scale filler(s), the compositions of the present technology may comprise optional materials such as a functional filler or other additional agents or additives. As referred to herein, a “functional filler” is a material that is operable to improve one or more properties of the composition. Such properties include one or more chemical or physical properties related to the formulation, function, or utility of the composition, such as physical characteristics, performance characteristics, applicability to specific end-use devices, applications, or environments, ease of manufacturing the composition, and ease of use or processing the composition after its manufacture. For example, stabilizers, wetting agents, rheology control agents, organic and inorganic fillers, pigments, colorants, fungicides, dispersing agents, adhesives, adhesion promoters, curing accelerators, tackifiers, waxes, de-aerators, mixtures thereof, and the like as known to those skilled in the art of microcellular formulations may be included and are contemplated as within the scope of the present technology. While certain additives may be known to exist in the prior art, the amount used with the present technology must be controlled to avoid adversely affecting the microcellular characteristics. These additives may be added to the composition at various times, and may also be pre-mixed as group or additive package. Optionally, the compositions may comprise up to about to 50% by weight of an additional filler, additive, or agent. Preferably, the composition may comprise up to about 30%, up to about 15%, or preferably up to about 5% by weight of additional filler or agent, depending on the desired features of the composition. It should be understood that in certain embodiments, additives or fillers may be optionally incorporated as a reduction of material costs, for example, and their presence may not necessarily be essential to a specific function of the composition. The use of additives and fillers should be balanced so as to minimize or avoid any interference with the manufacturing process.

### Methods of Manufacture

The reinforced microcellular urethane compositions of the present technology may be made using various mixing and manufacturing processes. Commercially, polyurethanes are commonly produced by reacting a liquid isocyanate(s) with a liquid blend of polyol(s), catalyst, surfactant, and other optional additives as desired. As described above, additives may include surfactants, stabilizers, catalysts, cross-linkers, chain extenders, flame retardants, blowing agents, pigments, and fillers. The isocyanate and resin blend are typically metered at a specified ratio, mixed to a homogenous blend, and dispensed into a mold or onto a surface to cure. As used herein, the term isocyanate index ratio is used to define the ratio of isocyanate groups to hydroxyl groups ([NCO]/[HO]×100). In various aspects, the isocyanate index ratio of the microcellular components of the present technology may range from about 65 to about 145, preferably from about 90 to about 110, and even more preferably, the isocyanate index ratio is from about 100 to about 106. Using a slight excess of [NCO] may reduce any tendency of the microcellular composition to shrink. Using a larger excess of [NCO] may provide higher strength, but may also be more brittle.

In various aspects, the multiple components used in the manufacture of the microcellular urethane composition are fed from tanks. The isocyanate component is preferably stored in a first tank, while the polyol component is stored in a second tank. The nano-scale filler is preferably not combined or stored with the isocyanate component. The nano-scale filler may be stored with the polyol component in the second tank, or may be delivered separately to be mixed with the polyol component prior to being introduced with the isocyanate portion for reaction. The second tank may also include the optional surfactant, catalyst, stabilizers, blowing agent, and other additives. Alternately, minor constituents may be stored in separate respective feed tanks. The tanks may be pressurized or blanketed with air, nitrogen, or an inert gas. Agitators may be provided to maintain uniform dispersions of the mixtures.

After the nano-scale filler is dispensed or otherwise mixed with a polyol component to form a polyol mixture, the polyol mixture may then be metered with an isocyanate component. As used herein, the term “metered” or “metering” is meant to include any type of measured, regulated, or otherwise recorded addition of components, including but not limited to mechanical or manual methods. The components may preferably be delivered by highly accurate metering pumps. In various aspects, the polyol component is present in an amount from 0.1% to 99.9% by weight and the isocyanate component is mixed, metered, or delivered such that it is present having an isocyanate index ratio of from about 65 to about 145, preferably from about 90 to about 110, even more preferably from about 100 to about 106. In various aspects, the polyol component may be present from about 50% to about 80% by weight of the reinforced microcellular urethane composition. In other aspects, it may be present from about 60% to about 70%, or about 65% by weight. Because both the density and the viscosity of the various liquid starting feed components vary with temperature, the temperature should be closely monitored in order to provide accurate weight ratios of the ingredients. Suitable means for temperature control can include heat exchangers or recirculation techniques.

In other aspects of the present technology, the methods may comprise dispersing a nano-scale filler with a polymer mixture. For example, the nano-scale filler may be added after the addition of the isocyanate, as opposed to metering the isocyanate component to a mixture of polyol and nano-scale filler. In these aspects, the polymer mixture may be prepared in advance to include a polyol component and an isocyanate component as described above. The nano-scale filler would be added, or dispersed into the polymer mixture and then mixed.

Mixers of various designs are available, including mechanical mixers and impingement mixers. In certain aspects, it may be preferred to have mechanical agitation. In other aspects, it may be preferred to rely on turbulence from injection of the various reactant streams at an elevated pressure. As a matter of design, such controlled delivery may be intermittent or continuous.

After the mixture/ingredients are thoroughly blended, they are deposited, or otherwise introduced, into an appropriate tooling device, or forming mold, where the mixture is allowed to expand and form into a useful reinforced microcellular urethane product. One shot, one-step techniques may be used in certain embodiments, wherein the reactants are combined simultaneously, and no chemical reaction takes place before such combination. The rate of delivery should be carefully controlled. For example, it should be sufficiently high enough such that the mixture fills the desired mold space prior to the viscosity becoming too high, or the mixture gels. Post mold shaping may be provided, if desired.

According to the present technology, the nano-scale fillers are used to reinforce the compositions. In various aspects, the addition of nano-scale fillers may not change the cell densities as compared to a homogeneously nucleated foam under similar conditions. In some embodiments, the nano-scale filler is provided in an amount sufficient to cause a change in overall density of the microcellular component based upon the amount of nano-scale fillers in the formulation. The inclusion of the nano-scale fillers component may increase the number of nucleation sites based on the amount of the nano scale fillers in the formulation. According to the present technology, however, the nano-scale fillers are provided with the intent of not altering the nucleation rates in the foaming process. In other words, while in some embodiments, the nano-scale filler may increase the density and provide a greater number of nucleation sites, the overall nucleation rate and kinetics of the reaction preferably does not change.

### EXAMPLES

The present technology is further illustrated through the following non-limiting examples.

### Example 1

Preparation of the microcellular urethane foam of Example 1 is carried out by using a blend of polyol mix components having 69.30 gm of Piothane EBA 50-2000 polyol, by initially dewatering and melting the material at about 50° C. An addition of 2.08 g of a stabilizer (Addovate SM450D from Rhein Chemie), 1.56 g of a hydrolytic stabilizer (Stabaxol P200 from Rhein Chemie), 0.01 g of a catalyst (DABCO 33LV from Air Products), 1.38 g of a surfactant (Addovate 3 from Rhein Chemie), and 0.07 g of nano-scale fillers (SiO₂ nano powder, 10 nm, 99.5% from Aldrich) is used to make the formulation. The materials are mixed homogeneously for at least about 2 minutes using an Arrow Triple blade mixer operating at about 2000 RPM to form a blend. The blend is kept at about 50° C. prior to any addition of isocyanate. The isocyanate used in this formulation is Mondur PC from Bayer Material Science and is kept at about 27° C. prior to being added to the polyol and additives blend. The blend of polyol is mixed with 30.6 g of isocyanate using an Arrow Triple blade mixer at about 2000 RPM for about 30 seconds. The mixture is then poured into a 150° F. preheated silicone mold release (E236 from Stoner) coated tool for the formation of a reinforced microcellular urethane foam. The part is removed from the tool after about 5 minutes and is post cured for about 8 hours at about 100° C. to obtain the optimal properties. The fully cured part is tested after about a week for dynamic stiffness, loss stiffness, damping properties, and transmissibility.

### Example 2

Preparation of the microcellular urethane foam of Example is 2 carried out by using a blend of two polyol components having (1) 55.54 g of Piothane EBA 50-2000 polyol, by initially dewatering and melting the material at about 50° C., and (2) 13.89 g of ARCOL E-351. An addition of 2.08 g of a stabilizer (Addovate SM450D from Rhein Chemie), 1.56 g of a hydrolytic stabilizer (Stabaxol P200 from Rhein Chemie), 0.02 g a catalyst (DABCO 33LV from Air Products), 1.39 g a surfactant (Addovate 3 from Rhein Chemie), and 0.17 g of nano-scale fillers (SiO₂ nano powder, 10 nm, 99.5% from Aldrich) is used to make the formulation. The materials are mixed homogeneously for at least about 2 minutes using an Arrow Triple blade mixer operating at about 2000 RPM. The blend is kept at about 50° C. prior to any addition of isocyanate. The isocyanate used in this formulation is Mondur PC from Bayer Material Science and is kept at 27° C. prior to being added to the polyol and additives blend. The blend of polyol is mixed with 30.34 g of isocyante using an Arrow Triple blade mixer at about 2000 RPM for about 30 seconds. The mixture is then poured into 150° F. preheated silicone mold release (E236 from Stoner) coated tool for the formation of a reinforced microcellular urethane foam. The part is removed from the tool after about 5 minutes and is post cured for about 8 hours at about 100° C. to obtain the optimal properties.

### Example 3

Preparation of the microcellular urethane foam of Example 3 is carried out by using a blend of two polyol components having (1) 69.82 g of Piothane EBA 50-2000 polyol, by initially dewatering and melting the material at about 50° C. An addition of 2.09 g of a stabilizer (Addovate SM450D from Rhein Chemie), 1.57 g of a hydrolytic stabilizer (Stabaxol P200 from Rhein Chemie), 0.02 g of a catalyst (DABCO 33LV from Air Products), 1.40 g of a surfactant (Addovate 3 from Rhein Chemie) and 0.17 g of nano-scale fillers (SiO₂ nano powder, 10 nm, 99.5% from Aldrich) is used to make the formulation. The materials are mixed homogeneously for at least about 2 minutes using an Arrow Triple blade mixer operating at about 2000 RPM to form a blend. The blend is kept at 50° C. prior to any addition of isocyanate. Two isocyanates are used for this formulation: Vestanat H12MDI and Mondur PC from Bayer Material Science; they are kept at 27° C. prior to being added to the polyol and additives blend. The blend of polyol is mixed with 25.14 g of aromatic isocyante and 4.78 g of Vestanat H12MDI using an Arrow Triple blade mixer at about 2000 RPM for about 30 seconds. The mixture is then poured into 150° F. preheated silicone mold release (E236 from Stoner) coated tool for the formation of a reinforced microcellular urethane foam. The part is removed from the tool after about 5 minutes and then post cured for about 8 hours at about 100° C. to obtain the optimal properties.

### Example 4

Preparation of the microcellular urethane foam of Example 4 is carried out by using a blend of two polyol components having (1) 54.79 g of Piothane EBA 50-2000 polyol, by initially dewatering and melting the material at about 50° C., and (2) 18.26 g of “ARCOL E-351”. The addition of 2.19 g of a stabilizer (Addovate SM450D from Rhein Chemie), 1.64 g of a hydrolytic stabilizer (Stabaxol P200 from Rhein Chemie), 0.02 g of a catalyst (DABCO 33LV from Air Products), 1.46 g of a surfactant (Addovate 3 from Rhein Chemie) and 0.18 g of nano-scale fillers (SiO2 nano powder, 10 nm, 99.5% from Aldrich) is used to make the formulation. The materials are mixed homogeneously for at least about 2 minutes using an Arrow Triple blade mixer operating at about 2000 RPM. The blend is kept at about 50° C. prior to any addition of isocyanate. Two isocyanates are used for this formulation: Vestanat H12MDI and Mondur PC from Bayer Material Science; they are kept at about 27° C. prior to being added to the polyol and additives blend. The blend of polyol is mixed with 3.8 g of aromatic isocyante and 22.65 g of Vestanat H12MDI using an Arrow Triple blade mixer at about 2000 RPM for about 30 seconds. The mixture is then poured a into 150° F. preheated silicone mold release (E236 from Stoner) coated tool for the formation of a reinforced microcellular urethane foam. The part is removed from the tool after about 5 minutes and then post cured for about 8 hours at about 100° C. to obtain the optimal properties.

TABLE 1

| | Exam- | Exam- | Exam- | Exam- |
|---|---|---|---|---|
| | ple 1 | ple 2 | ple 3 | ple 4 |
| Ingredient | Wt (g) | Wt (g) | Wt (g) | Wt (g) |
| Polyol | | | | |
| Polyol # 1 (Piothane EBA | 69.30 | 55.54 | 69.82 | 54.79 |
| 50-2000) | | | | |
| Polyol # 2 (Arcol E 351) | — | 13.89 | — | 18.26 |
| Additives | | | | |
| Hydrolytic Stabilizer (Stabaxol | 1.56 | 1.56 | 1.57 | 1.64 |
| P200) | | | | |
| Catalyst (DABCO 33LV) | 0.01 | 0.02 | 0.02 | 0.02 |
| Stabilizer (Addovate SM 450D) | 2.08 | 2.08 | 2.09 | 2.19 |
| Surfactant (Addovate 3) | 1.38 | 1.39 | 1.40 | 1.46 |
| Nano Fillers (Aldrich, 10 nm, | 0.07 | 0.17 | 0.17 | 0.18 |
| 99.5%) | | | | |
| Isocyanate | | | | |
| Modified Diisocyanate | 30.60 | 30.34 | 25.14 | 3.80 |
| (Aromatic) - (Mondur PC) | | | | |
| Aliphatic MDI (Vesatanat | — | — | 4.78 | 22.65 |
| H12MDI) | | | | |

Examples 5 through 8 are variations of the formulation similar in content to Example 1, modified to adjust the level of nano-scale filler present. Example 9 is a comparative example without any nano-scale filler present. Examples 5 through 8 were prepared in a manner similar to that of Example 1, described above. Their specific formulations can be found in Table 2.

TABLE 2

| | Exam- | Exam- | Exam- | Exam- | Comparative |
|---|---|---|---|---|---|
| | ple 5 | ple 6 | ple 7 | ple 8 | Example 9 |
| Ingredient | Wt (g) | Wt (g) | Wt (g) | Wt (g) | Wt (g) |
| Polyol | | | | | |
| Polyol System | 69.30 | 69.10 | 68.83 | 68.49 | 69.45 |
| Additives | | | | | |
| (Surfactant, | 5.03 | 5.02 | 5.00 | 4.97 | 5.05 |
| Stabilizer and | | | | | |
| Cataylst) | | | | | |
| Nano Fillers | 0.07 | 0.10 | 0.26 | 0.52 | 0.00 |
| Isocyanate | | | | | |
| Modified | 30.60 | 30.77 | 30.91 | 31.02 | 30.5 |
| Diisocyanate | | | | | |

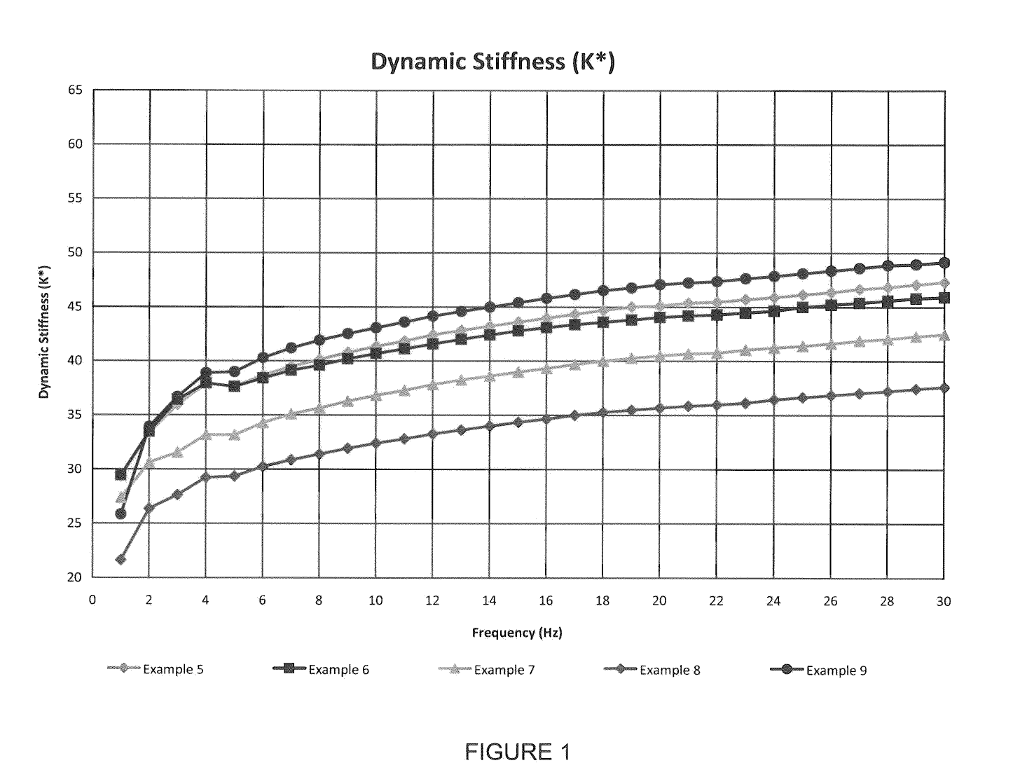

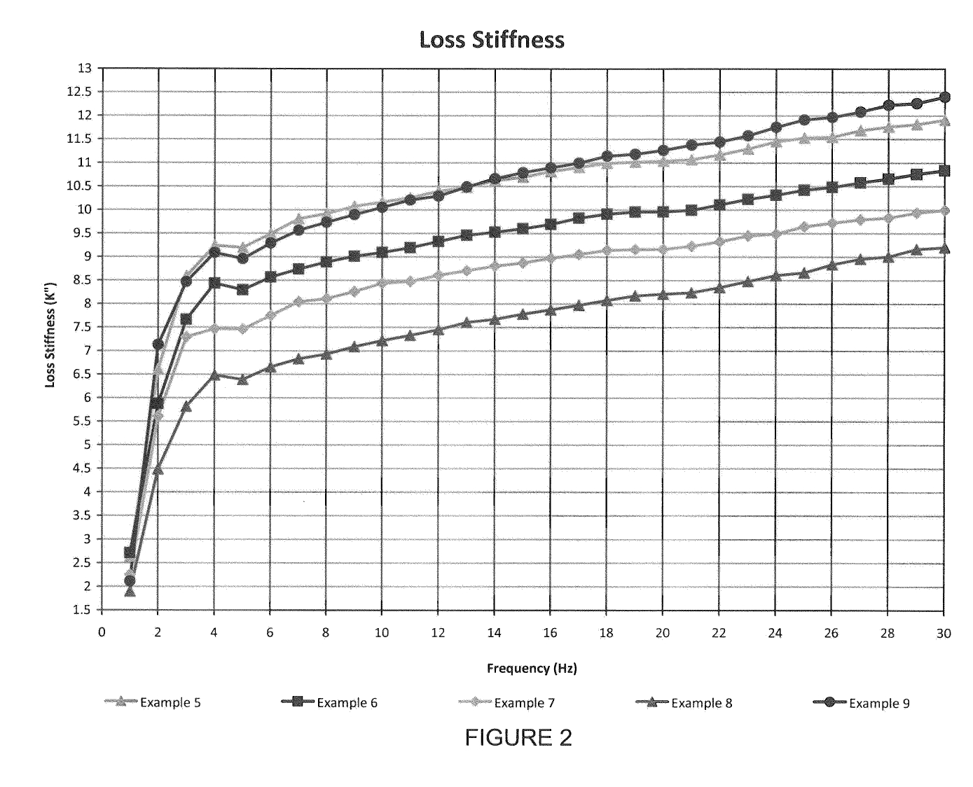

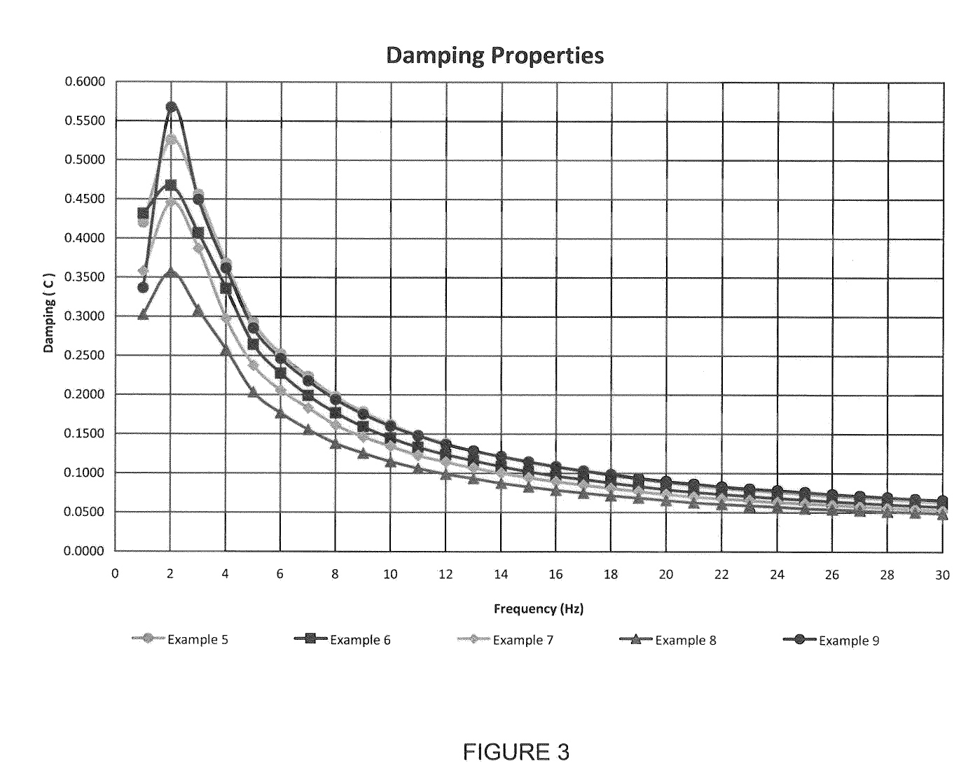

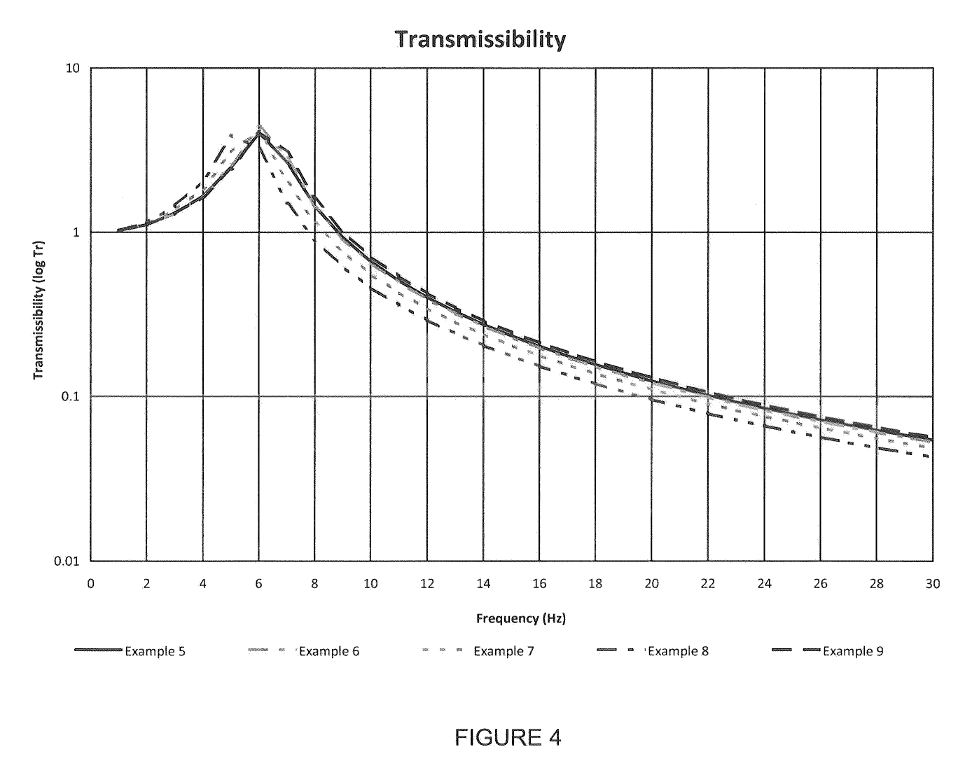

FIGS. 1-4 are respective graphs of dynamic stiffness, loss stiffness, damping properties, and transmissibility as a function of frequency for Examples 5-8 and the Comparative Example 9. The comparisons indicate that as the amount of nano-filler present is slightly increased from Example 5 (0.07 g) to Example 8 (0.52 g), compositions of the present technology exhibit enhanced dynamic stiffness, loss stiffness, damping properties, and transmissibility as a function of frequency.

The embodiments described herein are exemplary and not intended to be limiting in describing the full scope of compositions and methods of the present technology. Equivalent changes, modifications and variations of embodiments, materials, compositions and methods can be made within the scope of the present technology, with substantially similar results.

### Non-Limiting Discussion of Terminology:

The headings (such as “Introduction” and “Summary”) and sub-headings used herein are intended only for general organization of topics within the present disclosure, and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition and method.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested. Equivalent changes, modifications and variations of some embodiments, materials, compositions and methods can be made within the scope of the present technology, with substantially similar results.

As used herein, the words “desire” or “desirable” refer to embodiments of the technology that afford certain benefits, under certain circumstances. However, other embodiments may also be desirable, under the same or other circumstances. Furthermore, the recitation of one or more desired embodiments does not imply that other embodiments are not useful, and is not intended to exclude other embodiments from the scope of the technology.

As used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Although the open-ended term “comprising,” as a synonym of non-restrictive terms such as including, containing, or having, is used herein to describe and claim embodiments of the present technology, embodiments may alternatively be described using more limiting terms such as “consisting of or “consisting essentially of.” Thus, for any given embodiment reciting materials, components or process steps, the present technology also specifically includes embodiments consisting of, or consisting essentially of, such materials, components or processes excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include disclosure of all distinct values and further divided ranges within the entire range. Thus, for example, a range of “from A to B” or “from about A to about B” is inclusive of A and of B. Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

What is claimed is:

1. A reinforced microcellular urethane composition, comprising:
a polyol component;
an isocyanate component having an isocyanate index ratio of from about 65 to about 145; and
up to about 50% by weight of a nano-scale filler dispersed throughout the composition.

2. The composition of claim 1, wherein the polyol component is present in an amount from about 50% to about 80% by weight of the reinforced microcellular urethane composition.

3. The composition of claim 1, wherein the polyol component comprises a blend of at least two polyols selected from the group consisting of polyester polyols, polyether polyols, polycaprolactone polyols, polycarbonate polyols, and polytetrahydrofuran polyols.

4. The composition of claim 1, wherein the polyol component comprises a blend including a polyether polyol and a polyester polyol.

5. The composition of claim 4, wherein the polyol blend comprises from about 10% to about 50% by weight of polyether polyol and from about 50% to about 90% by weight of polyester polyol.

6. The composition of claim 1, wherein the isocyanate component comprises a blend of at least two isocyanates selected from the group consisting of o-tolidine diisocyanate (TODI), diphenylmethane diisocyanate (MDI), toluene diisocyanate (TDI), naphthalene diisocyanate (NDI), and p-phenylene diisocyante (PPDI).

7. The composition of claim 1, wherein the isocyanate component comprises an aromatic isocyanate.

8. The composition of claim 1, wherein the isocyanate component comprises diphenylmethane diisocyanate (MDI).

9. The composition of claim 1, wherein the nano-scale filler comprises an inert compound selected from the group consisting of nano-scale PTFE, nano-scale silica, carbon nanotubes, nano-scale graphite, and mixtures thereof.

10. The composition of claim 1, wherein the nano-scale filler comprises nano-scale silica present in an amount from about 0.01% to about 30% by weight of the reinforced microcellular urethane composition.

11. The composition of claim 1, wherein the nano-scale filler is present in an amount such that it does not change the nucleation rate.

12. The composition of claim 1, comprising an isocyanate index ratio from about 90 to about 110.

13. The composition of claim 1, comprising an isocyanate index ratio from about 100 to about 106.

14. A method for producing a reinforced microcellular urethane component, the method comprising:
dispersing a nano-scale filler with a polyol component to form a polyol mixture;
metering the polyol mixture with an isocyanate component in an amount having an isocyanate index ratio of from about 65 and about 145;
blending the resulting mixture;
depositing the mixture into a tooling device and forming a reinforced microcellular urethane component.

15. The method according to claim 14, wherein the nano-scale filler is present in an amount sufficient to cause a change in an overall density and number of nucleating sites of the microcellular urethane component.

16. The method according to claim 15, wherein the dispersing of the nano-scale filler with the polyol component does not change the rate of nucleation.

17. The method of claim 14, wherein the polyol component comprises a blend of at least two polyol components.

18. The method of claim 17, wherein the polyol blend comprises a polyether polyol and a polyester polyol.

19. The method of claim 14, wherein the isocyanate component comprises a blend of at least two isocyanate components.

20. The method of claim 19, wherein the isocyanate blend comprises an aromatic isocyanate and an aliphatic isocyanate.

21. The method of claim 14, wherein the nano-scale filler is dispersed in an amount from 0.01% to about 30% by weight of the microcellular urethane component, and further wherein the nano-scale filler comprises an inert compound selected from the group consisting of nano-scale polytetrafluoroethylene (PTFE), nano-scale silica, carbon nanotubes, nano-scale graphite, and mixtures thereof.

22. A method for producing a reinforced microcellular urethane component, the method comprising:
dispersing a nano-scale filler with a polymer mixture, the polymer mixture comprising a polyol component including a blend of polyether polyol and polyester polyol, and an isocyanate component present in an amount having an isocyanate index ratio of from about 65 to about 145;
blending the resulting mixture;
depositing the mixture into a tooling device and forming a reinforced microcellular urethane component.
